(19) United States
(12) Patent Application Publication
(10) Pub. No.: US 2002/0008717 A1
(43) Pub. Date: Jan. 24, 2002

(54) Input device, interface preparation system, data processing method, storage medium, and program transmission apparatus

(75) Inventors: Akira Sakaguchi, Tokyo-to (JP); Masato Yokote, Kawasaki-shi (JP)

Correspondence Address: Louis P. Herzberg,, Intellectual Property Law Dept., IBM Corporation, P.O. Box 218, Yorktown Heights, NY, 10598, US

(73) Assignee: International Business Machines Corporation, Armonk, NY

(21) Appl. No.: 09/838,000

(22) Filed: Apr. 19, 2001

(30) Foreign Application Priority Data
Apr. 17, 2000 (JP) 2000-115285

(51) Int. Cl. G06F 3/00

(52) U.S. Cl. 345/764

(57) ABSTRACT

It is one object of the present invention to simplify the operations involved in the preparation of an input screen to be used as a user interface, and to ensure the quality of the operations is stable.

An input device, which has a graphical user interface and which accepts, as entries, the manipulation by a user to an input screen of a display device, comprises: a web browser 24; and an object handler for controlling an object used for input, wherein an input screen is formed using both an image that is displayed on the display device by the web browser 24 and an object window 34 that is displayed on the display device by the object handler, and wherein the object handler performs a process in accordance with an operation performed by the user relative to the object window 34, and also instructs the web browser 24 to interact with a process corresponding to the operation.

### DETAILED DESCRIPTION OF THE INVENTION

1. Field of the Invention

The present invention relates to a user interface that accepts, as an entry, manipulation by a user of buttons presented on an input screen on a display device.

2. Background Art

Among systems for which GUIs (Graphical User Interfaces) are used to accept commands and the entry of data, there are systems wherein input screens are prepared using HTML and JavaScript. That is, a process corresponding to a predetermined event is written in JavaScript and takes the form of an input screen that is prepared using HTML, with which a process corresponding to an event that resulting from the entry of data is performed. A system that has an input screen of this type is, for example, an automatic teller machine, such as is installed in banks.

For business use, this type of terminal device prepares various input screens for individual services and accepts entries from users. Therefore, an HTML file constituting an input screen must be prepared for each service. Since both HTML and JavaScript are interpreted languages, when HTML file for a new input screen is prepared, all the logic relative to input buttons that are arranged on the input screen must be executed and examined.

Visual effects obtained when operations involving the manipulation of individual buttons on a prepared input screen must be examined. Here, let us assume that there is a multi-button arrangement wherein individual toggle buttons can be selected. In this case, to form an image that can be used for the visual identification of an individual toggle button, two image files must be prepared: one that is used for a representation of the button when it has not been selected, and another that is used for a representation of the button when it has been selected. Then, to insure that the initial appearance of the button, before being selected, changes when it is selected, the button must be actually depressed, by being clicked on with a mouse, for example. This process must be repeated for all the buttons distributed across the input screen.

Furthermore, to change the design of a screen, such as altering the location of a button on an input screen prepared using HTML and JavaScript, the description of the HTML file must be corrected.

### PROBLEMS TO BE SOLVED BY THE INVENTION

As is described above, in a system wherein HTML and JavaScript are used to prepare an interface, such as one for user input, an HTML file that includes JavaScript descriptions of various processes for specific screens must be prepared, a demanding requirement.

Further, since JavaScript is employed to write processes for displaying buttons on an input screen, processes for subsequently executing tasks requested by the manipulation of switching devices, such as is effected by clicking on a button, and processes for shifting operations to application programs, to develop user interfaces, many operations and tests are required.

In addition, since a process performed in response to an event is written in JavaScript, the operation of the process will be unstable due to differences in JavaScript specifications (differences in versions). Therefore, the specifications for compatible JavaScripts are limited, and accordingly, the number of web browsers that can use a system is limited.

It is, therefore, one object of the present invention to simplify the operations involved in the preparation of an input screen to be used as a user interface, and to ensure the quality of the operations is stable.

It is another object of the present invention to avoid, to the extent possible, the use of JavaScript coding in the process for preparing an input screen, to be used as a user interface, and to provide an input screen that is not dependent on a specific web browser and development environment.

### SUMMARY OF THE INVENTION

To achieve the above objects, according to the present invention, an input device, which has a graphical user interface and which accepts, as entries, the manipulation by a user to an input screen of a display device, comprises: a browser; and an application system for controlling an object used for input, wherein an input screen is formed using both an image that is displayed on the display device by the browser and the object that is displayed on the display device by the application system, and wherein the application system performs a process in accordance with an operation performed by the user relative to the object, and also instructs the browser to interact with a process corresponding to the operation.

The application system manages the object using the unit page that is set in accordance with a specific entry. When the user enters a request to display another page, the application system displays objects in accordance with the unit page, and instructs the browser to change an image displayed by the browser. This configuration is preferable because an input screen can be prepared for each specific input, such as a routine operation, and the management and display processes are simplified.

According to the present invention, an input device, which has a graphical user interface and which accepts, as an entry, the manipulation by a user to an input screen on a display device, comprises: an object definition file for defining a function for an object used for input and a display form of the object used on the display device; an object window on the display device in which the object, as defined by the object file, is depicted; and an event processor for detecting an event that has occurred in response to the manipulation of the object by a user, and for performing a process corresponding to the event. The location whereat the object is displayed is defined by a parameter included of the object definition file.

According to the present invention, an interface preparation system for preparing a graphical user interface that accepts, as an entry, the manipulation by a user of objects included on an input screen on a display device, comprises: an object definition file for defining a function of an object for input and a display form for the object depicted on the display device; an object window in which the object is depicted on the display device as is defined by the object file; and an event processor for detecting an event that has occurred in response to the manipulation of the object by a user, and for performing a process corresponding to the event, wherein the function of the object and the description of the display form for the object are written in the object definition file for each unit page that is prepared in accordance with a specific entry, in order to design the input screen.

The object definition file defines, for each object, the function and the display form of the object by using a specific format that includes information for specifying a page whereon the object is arranged, information indicating the type of the object, and information concerning the location of the object. This configuration is preferable because, when an object is defined in accordance with a predetermined format that is provided by the object definition file, an input screen can be easily designed on which a desired object is positioned at an arbitrary location. In addition to the above information, information for specifying image data used for displaying an object, and information for designating text that is displayed adjacent to the object can be written in the object definition file.

The object is displayed for each page in the object window, and the event processor performs a page switching process for deleting a page displayed in the object window and displaying the next page. This configuration is preferable because the input screen can be designed for a specific unit entry, such as a routine operation, and the management and display processing can be simplified.

The user interface preparation system further comprises: a browser for displaying a predetermined image on the display device; and overall control means for permitting the page switching process performed by the event processor to interact with the switching of a page displayed by the browser.

This configuration is preferable because a variety of input screens can be designed by combining various backgrounds and objects.

According to the present invention, a data processing system for accepting, as an entry, the manipulation by a user to an input screen on a display device and for performing a corresponding process, comprises the steps of: using a browser to display an image on the display device, and to form an input screen by combining the image and an object used for input that is controlled by a process separate from the browser; detecting an event that has occurred as a result of the manipulation of the object by the user; and performing a predetermined process in accordance with the detected event, and permitting the predetermined process to interact with the browser.

According to the present invention, a storage medium is provided which stores a program, which can be read by an input means of a computer and instruct the computer to perform: a process for reading a definition for an object, given on a desired page extracted from an object definition file, which defines a function of the object, and a display form for the object on the display device for each page that is set up in accordance with specific input; a process for displaying the object on the display device in accordance with the definition that is read; a process for detecting an event that has occurred as a result of the manipulation of the object by the user; and a process that is performed in accordance with the event. his configuration is preferable because a user interface having a stable quality, and that is easily prepared as an input screen, can be prepared by a computer in which the program is installed.

The process for displaying the object includes a program for permitting a browser, mounted in the computer, to display a predetermined image, and for preparing the input screen by combining the object with the predetermined image. This configuration is preferable because a variety of input screens can be designed by combining various backgrounds and objects. According to the present invention, a program transmission apparatus comprises: storage means for storing a program that permits a computer to perform a process for reading a definition for an object of a desired page from an object definition file that defines a function of the object and a form of the object displayed on the display device for each page that is set up in accordance with specific input, a process for displaying the object on the display device in accordance with the definition that is read, a process for detecting an event that has occurred as a result of the manipulation of the object by a user, and a process that is being performed in accordance with the event; and transmission means for reading the program in the storage means and for transmitting the program. This configuration is preferable because a user interface having a stable quality, which is easily prepared as an input screen, can be provided by a computer that has downloaded the program.

The process for displaying the object includes a program permitting a browser mounted in the computer to display a predetermined image, and for preparing the input screen by combining the object with the predetermined image. This configuration is preferable because a variety of input screens can be designed by combining various backgrounds and objects.

### PREFERRED EMBODIMENT

The present invention will now be described in detail during the course of the preferred embodiment, given while referring to the accompanying drawings. FIG. 1 is a diagram for explaining the general configuration of an interface control system according to the preferred embodiment. The interface control system of this embodiment displays an input screen on a display device for the entry of commands or data. When a user clicks on a button on the input screen, various processes are performed in accordance with the event that has occurred as a result of the object manipulation.

In FIG. 1, an overall controller 10 controls the operation of the complete system. An HTML file display controller 20 controls the display of an HTML file via a web browser. An object controller 30 displays object windows 34 that are the objects used for input, and accepts various entries, while performing processes corresponding to selected events. An input device 50 is used to enter data through operations performed in the object window. A setting unit 60 sets up an initial setting file and an object definition file, which will be described later. And a web browser activation unit 70 activates a web browser.

In this embodiment, the HTML file, which is displayed by the HTML file display controller 20, and the object windows 34, which are displayed by the object controller 30, are combined to form an input screen. The screen formed using the HTML file and the object windows 34 is referred to as a page. In this embodiment, the HTML file displayed by the web browser 24 is used as the background for the input screen, and processes for an event, such as the display of buttons for inputting commands and data, and clicking on a displayed button, are performed using various objects that are controlled by the object controller 30. In this embodiment, it should be noted that the components other than the web browser 24 (hereinafter collectively referred to as an object handler) are provided by an application program that runs on a JavaVM (Java Virtual Machine).

In FIG. 1, in this embodiment, the overall controller 10 comprises: a flow controller 11, for exercising control of the HTML file display controller 20 and the object controller 30 for the display of a page; an initial setting reader 12 and an initial setting file 101, for inputting the initial setting to the flow controller 11; an object definition file reader 13 and an object definition file 102, for setting up various objects; and a page show instruction unit 14, for instructing the HTML file display controller 20 and the object controller 30 to display a page.

The HTML file display controller 20 comprises: a URL display instruction unit 21, for receiving an instruction, from the page show instruction unit 14 of the overall controller 10, to instruct the web browser 24 to display the URL of an HTML file; an inter-process command transmission unit 22, for sending a display instruction issued by the URL display instruction unit 21 to the process of the web browser 24; and the HTML file display instruction unit 23 and the web browser 24, for displaying a web page on the display device in accordance with an instruction received from the inter-process command transmission unit 22.

The object controller 30 is a component that corresponds to the “application system” described in the claims for this specification. The object controller 30 is executed by a separate process performed by the HTML file display controller 20, and these two components are identified as different applications by the operating system. Since the object controller 30 is executed by a process separate from that used for the HTML file display controller 20, if application logic is provided for the object controller 30, the controller 30 can continue to provide the service, even if abnormal termination of the HTML file display controller 20 occurs. Further, a barrier can be easily removed by re-activating the HTML file display controller 20. The object controller 30 also includes an application class 40 that is operated using JavaVM, which is provided in accordance with an object for a service. The object controller 30 comprises: an application class registration unit 31, for registering the application class 40 that is to be executed in accordance with an instruction from the page show instruction unit 14 of the overall controller 10; a page hide/show instruction unit 32, for hiding/showing one of the object window 34 that is an object used for page input; an object display unit 33, for displaying the object windows 34 on the display device in accordance with the instruction received from the page hiding/showing instruction unit 32; an object event controller 35, for extracting a predetermined event from operations performed with the object windows 34, and for transmitting the event to the application class 40; an event processor 36, which is included in the application class 40 and which performs a process that is consonant with an event that has occurred; and a page show request unit 37, for issuing, when a page is to be updated as a process corresponding to an event, a page updating request to the flow controller 11 of the overall controller 10.

In addition to the event processor 36, objects are prepared for the application class 40 to execute a page hide pre-process 41, a page show pre-process 42, a page show post-process (1) 43, or a page show post-process (2) 44, for displaying a page, in accordance with an instruction received from the page hiding/showing instruction unit 32, corresponding to the application class 40. The page hide pre-process 41 defines a process that is to be performed before a currently displayed page is deleted in association with the switching of pages. The page show pre-process 42 defines a process that is to be performed before a page, obtained following the change, is displayed in accordance with the page change. The page show post-process (1) 43 defines a process that is to be performed after a page, obtained following the change, is displayed in accordance with the page change.

The page show post-process (2) 44, as well as the page show post-process (1) 43, defines a process that is to be performed after the page obtained following the change is displayed. The defined process is performed after the page show post-process (1) 43 has been completed.

FIG. 2 is a diagram showing an example page on an input screen that is displayed on the display device according to the embodiment. FIG. 3 is a diagram for explaining the structure of the page shown in FIG. 2. Referring to FIGS. 2 and 3, a page 200 includes a window 201 for the web browser 24 that displays the background prepared by the HTML file, and object windows 34 that are generated by the object controller 30 of the embodiment in FIG. 1.

Since the object windows 34 have the topmost attribute, they are always displayed on the window 201 of the web browser 24.

In the window 201, provided by the web browser 24, the background prepared by the HTML file is displayed as is described above. As is shown in FIG. 2, sentences, such as the title of page 200 (“Place of employment”) and an input instruction (“Select your place of employment and depress ‘confirm’.”) can also be displayed in the background. In this embodiment, these sentences are displayed merely to support the manipulation of object performed by a user, and no other function is added. However, various functions, such as the replaying of moving picture data or audio data, that are available using the browser 24 can also be added. In this embodiment, the web browser 24 has been employed; however, the idea of the invention is not limited to this. The “browser” described in the claims of this specification can be any application used for managing display information, such as image information, for each page, and for obtaining a command, for changing and displaying a predetermined page, and for providing a display of information that is managed by a page differing from the current page. That is, this concept includes the use of various applications, such as the Acrobat Reader by Adobe Systems, Inc., Word by Microsoft Corp. or Freelance by Lotus Development Corp., and is not limited by the HTML file display controller 20, which has been explained in this embodiment.

In accordance with the contents of a process controlled by the object controller 30, the object windows 34 provide objects having various functions, such as buttons, toggle buttons, labels, image labels, text, and ten-key pads. In FIG. 2, as the objects included in the object windows 34, a toggle button object 211, a label object 212 and a button object 213 are displayed on page 200.

The toggle button object 211 includes multiple buttons constituting the object windows 34 that regard the last depressed button as the selected button. Buttons other than the last depressed (selected) button are represented as non-selected buttons, even when they were previously depressed. To select one button from the toggle button object 211, the mouse cursor is positioned and clicked on the target button. When the mouse is used to click on the button, the button image indicating non-selection is exchanged with the button image indicating selection, so as to thereby indicate that the target button has been selected. A button that was previously selected is concurrently changed from a button image indicating selection to a button image indicating non-selection. Therefore, two button images, a button image indicating selection and a button image indicating non-selection, are prepared for each button included in the toggle button object 211.

The label object 212, a text display area that is not accompanied by input, is included in the object windows 34, wherein designated text is displayed in accordance with a designated attribute. The text and attribute are designated by using the object definition file 102, as will be described later.

The button objects 213 are part of the object windows 34 in which a reaction is displayed when, after being clicked on with a mouse, a specific button is depressed. Thus, a pre-depression image and a post-depression image must be prepared for each of the button objects 213. Then, when a mouse is used to click on one of the button objects 213, the button image is changed from the pre-depression, to the post-depression, and then to the pre-depression image. FIG. 4 is a diagram showing another example of an input screen page that is displayed on the display device in accordance with the embodiment.

In FIG. 4, on page 200, a button object 213, an image label object 214, a text object 215 and a ten-key object 216 are displayed as the object windows 34.

The image label object 214 is an object window 34 for displaying an image designated by the object definition file 102.

The text object 215 is a text input/output area that is accompanied by the input, and an object window 34 for displaying the input text using an input device 50, such as a keyboard or a mouse.

The ten-key object 216 is an object window 34 for displaying a ten-key keypad for the entry of numerals using an input device 50, such as a mouse or a keyboard. A pre-depression image and a post-depression image are prepared for each key in the ten-key keypad that is displayed in the ten-key object 216, and when the mouse cursor is moved to a predetermined key and is clicked on the key, the image of that key is changed to the post-depression image. Thus, visual effects can be provided that make it appear the user physically depressed the key. The text object 215 and the ten-key object 216 may interact, and the numerals entered using the ten-key object 216 may be used as the entries for the text object 215.

In addition to the above types, other types of object windows 34 may be provided as needed. Therefore, object windows 34 having various functions can be set up in accordance with the contents that are provided as a user interface in this embodiment (e.g., the service contents when this embodiment is applied for an automatic teller machine installed in a bank), and can be displayed on the page 200.

FIG. 5 is a flowchart for explaining the processing performed for the embodiment. The page show processing and processing corresponding to an event in accordance with the embodiment will be explained while referring to FIGS. 1 to 5. Initially, the web browser activation unit 70 in FIG. 1 activates the web browser 24 (step 501). In the web browser 24, the HTML file display instruction unit 23 is resident as a Java applet that runs in JavaVM. As the web browser 24 is activated, the object handler is also activated.

When the object handler is activated, first, the initial setting reader 12 reads the initial setting file 101 and transmits it to the flow controller 11 (step 502). FIG. 6 is a diagram showing an example for the initial setting file 101. In FIG. 6, the name of a first page displayed when the object handler and the web browser 24 are activated, the path of the object definition file that constitutes the pertinent page, the path of an HTML file, and a font are designated in the initial setting file 101. The flow controller 11 starts the page show operation in accordance with the contents of the initial setting file 101, which is read by the initial setting reader 12.

Under the control of the flow controller 11, the object definition file reader 13 reads the object file definition file 102 for an object that forms the first displayed page, and transmits the object definition file 102 to the page show instruction unit 14 (step 503). FIG. 7 is a diagram showing an example format for the object definition file 102, and FIG. 8 is a diagram showing the description of the object definition file 102 used to display the object windows 34 on page 200 in FIG. 2, using the format shown in FIG. 7.

In FIG. 7, for each object, the name of a page whereon the pertinent object window 34 is displayed, the object type, the name of an object and the name of a group the object belongs to, and the image, the style and the location when the object window 34 is displayed are designated. Therefore, the object definition file reader 13 reads an object including the name of a page for which display was instructed by the flow controller 11, so that the object that constitutes the pertinent page can be obtained. In this embodiment, the object can be identified by the object controller 30 in accordance with its name or type, and includes a command set for controlling the display or input/output. Specifically, the object is at least one of the concepts shown in FIG. 7, including a button object, a toggle button object, a label object, an image label object, a text object and a ten-key object.

In FIG. 8, the button object 213 for a confirmation button and a cancel button, the toggle button object 211, consisting of six buttons, and the label object 212 are defined as objects having the page title “AL0010”. As is described above, since an attribute, such as the display location of the object windows 34, and a file name designating an image are defined by the object definition file 102, the operation for changing the display location and for ascertaining a change that is to be made can be performed more simply than when the display location of an object is defined in the HTML. In this embodiment, an attribute such as the display location is defined by the object definition file 102, but an attribute can also be defined as a class of an application system.

Following this, based on the initial setting file 101, read by the initial setting reader 12, and the object definition file 102, read by the object definition file reader 13, the page show instruction unit 14 instructs the HTML file display controller 20 and the object controller 30 to display a desired page (step 504).

When the HTML file display controller 20 receives the display instruction from the page show instruction unit 14 of the overall controller 10, the URL display instruction unit 21 transmits, via the inter-process command transmission unit 22, the URL of the HTML file that corresponds to the page name to the HTML file display instruction unit 23 that is resident in the web browser 24.

In parallel with this process, the application class registration unit 31 of the object controller 30 registers, as an execution target, the application class 40 that is set by the initial setting file 101 and that includes an object that is to be provided first. Then, the page hide/show instruction unit 32 employs the application class 40, registered by the application class registration unit 31, to perform a process sequence for displaying the object windows 34.

Specifically, when a page is currently being displayed, the page hide pre-process 41 is performed, and the object display unit 33 deletes all the object windows 34 on the currently displayed page (step 505). It should be noted that when the first page is displayed there is no previously displayed page, so that the above process is not performed. As a specific page hide pre-process 41, a value is stored in a directory that is used in common. The page show pre-process 42 is performed, and an instruction is issued to the object display unit 33 to display all the object windows 34 on the page to be displayed (step 506). As a specific page show pre-process 42, text received from the text object 215 of the previous page is displayed, whether or not toggle buttons that are to be eliminated are selected, or whether or not the object that is to be displayed is determined.

When the page hide pre-process 41 and the page show pre-process 42 have been performed, the HTML file display instruction unit 23, which is resident in the web browser 24, displays an HTML file in the window of the web browser 24 on the display device based on the URL that is received via the inter-process command transmission unit 22 (step 507). In accordance with an instruction issued by the page hide/show instruction unit 32, the object display unit 33 displays, on the display device, the object windows 34 that are is defined by the object definition file 102 (step 508). In this embodiment, at the separate steps, the HTML file is displayed, and thereafter the object windows 34 are displayed. However, the HTML file display controller 20 and the object controller 30 may be synchronized with each other to perform the above steps in parallel.

Immediately after the object windows 34 are displayed, the page hide/show instruction unit 32 asynchronously performs the page show post-process (1) 43, as needed, by using another thread (step 509). Specifically, the lid of a scanner is opened, printing is performed using a printer, or data are read from a card. After the page show post-process (1) 43 has been completed, the page show post-process (2) 44 is performed (step 510). Specifically, a page is changed in accordance with the reading of the card data.

When the HTML file and the object windows 34 are displayed, the input for an object is ready. A user refers to the page Ada on the input screen that is displayed on the display device, and employs an input device 50, such as a mouse or a keyboard, to enter data, such as by clicking on the object window 34.

When the user has entered data, the object event controller 35 detects the occurrence of an event, and performs an input acceptance process for calling the event processor 36 in the application class 40 (step 511). The event processor 36 performs an event process, corresponding to the detected event, under the control of the object event controller 35 (step 512).

The processing sequence from the time data is input by the user until the event processing corresponding to the detected event is performed is repeated as needed, until the input operation for the displayed page is completed (e.g., the button object 213, such as “confirm” or “complete”, is clicked on).

When the input operation for the displayed page has been completed, all the processing is terminated, or there is a page shift to the next page. Depending on the processing performed for the event, all the processing is terminated after the corresponding event process has been completed (step 513). When there is a page shift to the next page, in accordance with the processing performed for the event, program control is shifted to the page show request unit 37, which thereafter transmits a page shift request to the flow controller 11 of the overall controller 10 (steps 514 and 515). Under the control of the flow controller 11, the process following step 503, whereat the object definition file reader 13 reads the object definition file 102 for the next page, is performed. Further, as needed, the HTML file for forming the background is exchanged for another HTML file.

FIG. 9 is a diagram showing an example description for the application class 40. In FIG. 9, onUnload 914 corresponds to the page hide pre-process 41, onLoad 911 corresponds to the page show pre-process 42, onShow 912 corresponds to the page show post-process (1) 43, onShowComp 913 corresponds to the page show post-process (2) 44, eventperformed 915 corresponds to the event processor 36, and changePage 916 corresponds to the calling of a page show instruction for the page show request unit 37. The settings for the titles on the object windows 34, such as display, non-display, input enabled, input disabled and position change, are arbitrarily requested from the page show request unit 37 by the application class 40, and are thereafter applied.

As is described above, according to the embodiment, the page on the input screen is prepared by separately using an HTML file to form a background and the object windows 34 to accept the input operation and to perform various processes. The logic of the process for the input operation is included in the object handler, which is an application program separate from the web browser 24. Therefore, JavaScript need not be used to describe the logic for each input screen, thus simplifying the preparation of the input screens.

In addition, since the object windows 34 are defined by the object definition file 102 (see FIG. 7) using a predetermined format for each page, the system developer can very easily set up the object window 34, even without knowing the code or the grammar used for a programming language (e.g., Java) that implements the object handler.

Further, since the object definition file 102 is employed to define the object windows 34 that is prepared in advance, a page having stable object windows 34 can be easily prepared, and tests need not be conducted for each page to examine the logic of the processes and the display states of the object windows 34. Furthermore, when the description of the object definition file 102 is changed, the size and the display location of the object windows 34 can be corrected more easily than when the description of the HTML file is corrected.

Also, as is described above, since in this embodiment, the JavaScript code is not employed to write the logic for a process or to provide an object, the user interface of the embodiment is not limited to specifications prepared using JavaScript and does not depend on the web browser. In this embodiment, the HTML file is employed only to provide background; however, using JavaScript, a predetermined function may be provided for the HTML file so that it can interact with the function that is provided by the object handler. In this embodiment, the background is prepared by using the HTML file, but it may also be prepared by using another data form.

### ADVANTAGES OF THE INVENTION

As is described above, according to the present invention, the operations to prepare an input screen as a user interface can be simplified, and a stable operation can be ensured.

Further, according to the present invention, the use of JavaScript code can be avoided, to the extent possible, during the processing performed to prepare an input screen for use as a user interface, and an input screen that does not depend on a web browser, and a development environment for such an input screen can be provided.

### BRIEF DESCRIPTION OF THE DRAWINGS

FIG. 1 is a diagram for explaining the general configuration of an interface control system in accordance with the preferred embodiment of the present invention.

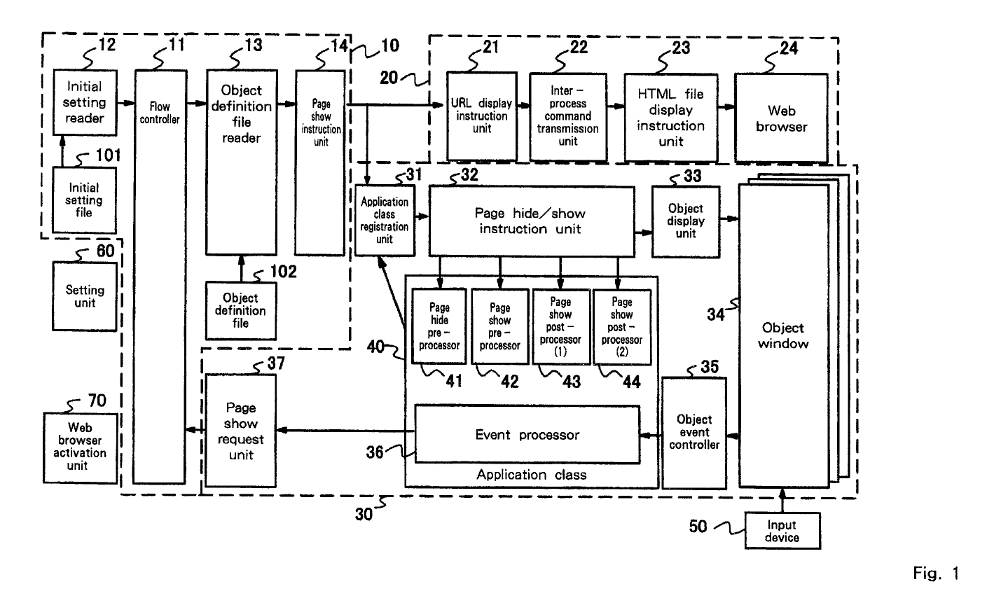

FIG. 2 is a diagram showing an example page on an input screen displayed on a display device in accordance with the embodiment.

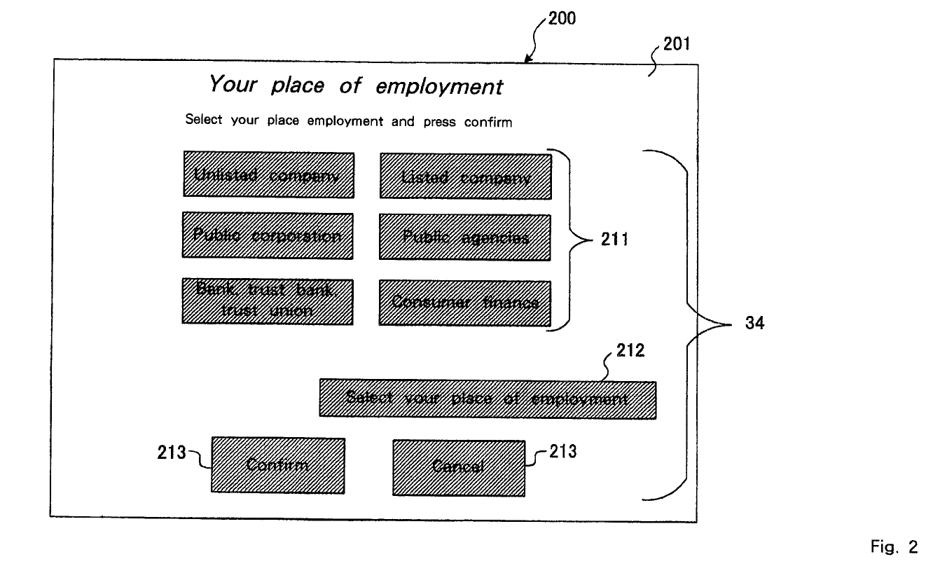

FIG. 3 is a diagram for explaining the structure of the page shown in FIG. 2.

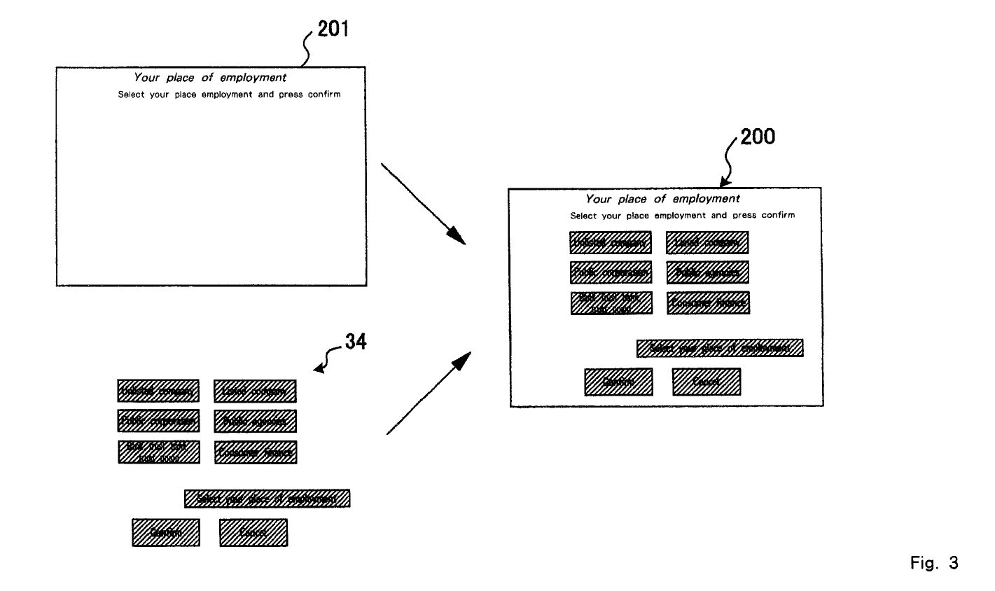

FIG. 4 is a diagram of another example page on an input screen displayed on a display device in accordance with the embodiment.

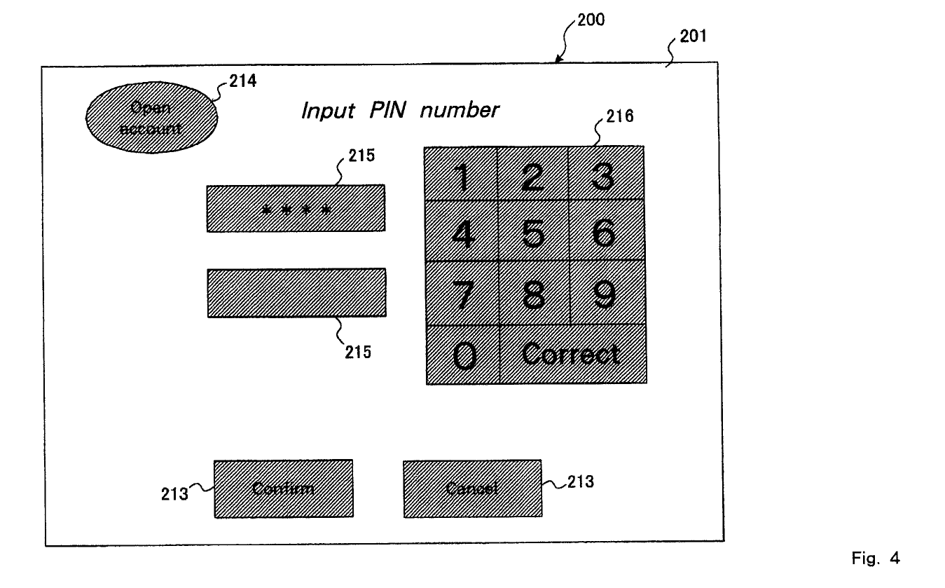

FIG. 5 is a flowchart for explaining the processing performed for the embodiment.

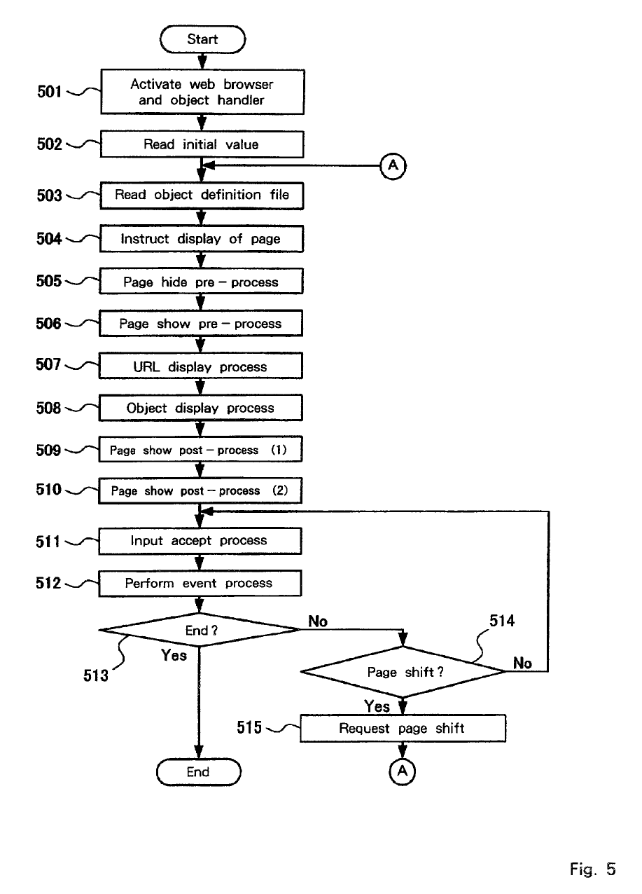

FIG. 6 is a diagram showing an example initial setting file in accordance with the embodiment.

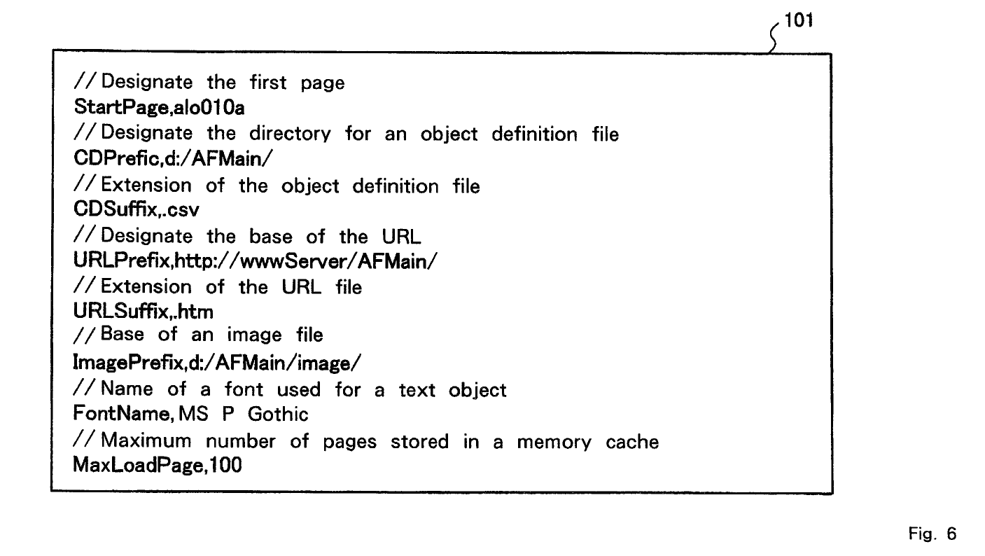

FIG. 7 is a diagram showing an example format for an object definition file in accordance with the embodiment.

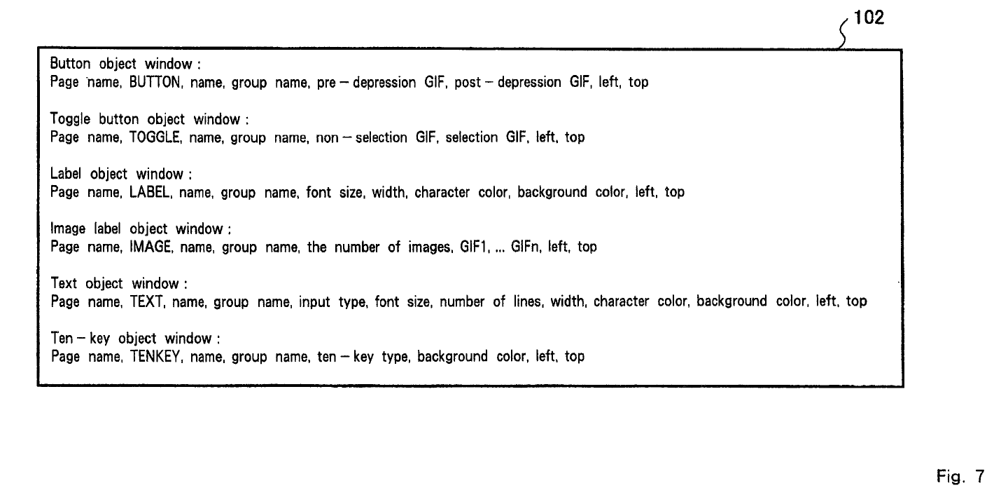

FIG. 8 is a diagram showing a description of the object definition file used to display the object window for the page shown in FIG. 2 using the format in FIG. 7.

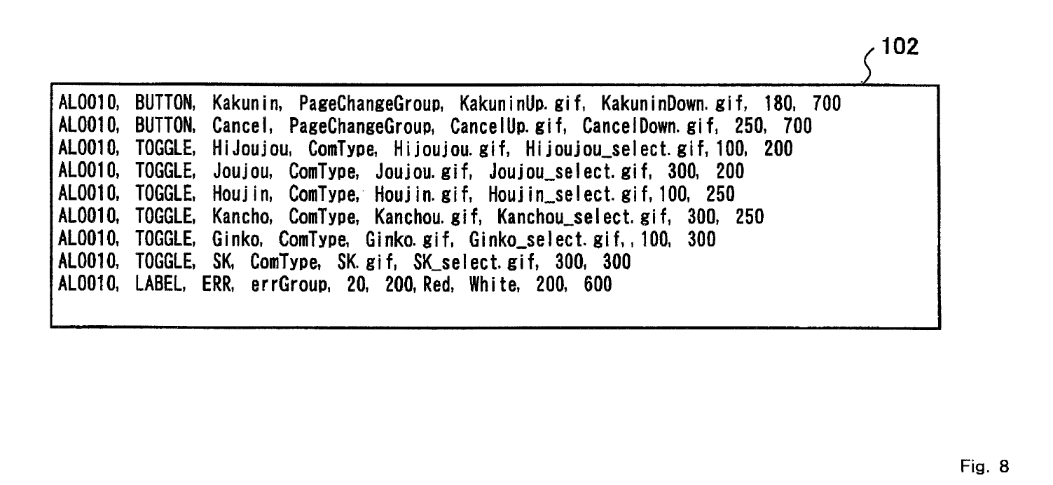

FIG. 9 is a diagram showing an example description provided for an application class in accordance with the embodiment.

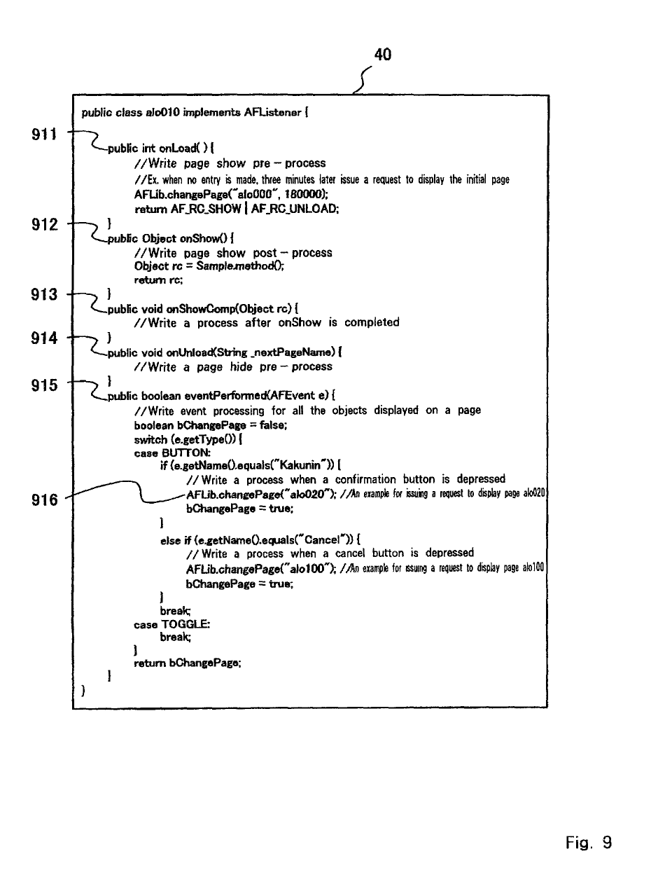

### DESCRIPTION OF THE SYMBOLS

10: Overall controller

11: Flow controller

12: Initial setting reader

13: Object definition file reader

14: Page show instruction unit

20: HTML file display controller

21: URL display instruction unit

22: Inter-process command transmission unit

23: HTML file display instruction unit

24: Web browser

30: Object controller

31: Application class registration unit

32: Page hide/show instruction unit

33: Object display unit

34: Object windows

35: Object event controller

36: Event processor

37: Page show request unit

40: Application class

41: Page hide pre-process

42: Page show pre-process

43: Page show post-process (1)

44: Page show post-process (2)

50: Input device

60: Setting unit

70: Web browser activation unit

200: Page

201: Window

211: Toggle button object

212: Label object

213: Button object

214: Image label object

215: Text object

216: Ten-key object

1. An input device, which has a graphical user interface and which accepts, as entries, the manipulation by a user to an input screen of a display device, comprising:
a browser; and
an application system for controlling an object used for input,
wherein an input screen is formed using both an image that is displayed on said display device by said browser and said object that is displayed on said display device by said application system, and
wherein said application system performs a process in accordance with an operation performed by said user relative to said object, and also instructs said browser to interact with a process corresponding to said operation.

2. The input device according to claim 1, wherein said application system manages said object using the unit page that is set in accordance with a specific entry; and wherein, when said user enters a request to display another page, said application system displays objects in accordance with said unit page, and instructs said browser to change an image displayed by said browser.

3. An input device, which has a graphical user interface and which accepts, as an entry, the manipulation by a user to an input screen on a display device, comprising:
an object definition file for defining a function for an object used for input and a display form of said object used on said display device;
an object window on said display device in which said object, as defined by said object file, is depicted; and
an event processor for detecting an event that has occurred in response to the manipulation of said object by a user, and for performing a process corresponding to said event.

4. The input device according to claim 3, wherein the location whereat said object is displayed is defined by a parameter included of said object definition file.

5. An interface preparation system for preparing a graphical user interface that accepts, as an entry, the manipulation by a user of objects included on an input screen on a display device, comprising:
an object definition file for defining a function of an object for input and a display form for said object depicted on said display device;
an object window in which said object is depicted on said display device as is defined by said object file; and
an event processor for detecting an event that has occurred in response to the manipulation of said object by a user, and for performing a process corresponding to said event,
wherein said function of said object and the description of said display form for said object are written in said object definition file for each unit page that is prepared in accordance with a specific entry, in order to design said input screen.

6. The interface preparation system according to claim 5, wherein said object definition file defines, for each object, said function and said display form of said object by using a specific format that includes information for specifying a page whereon said object is arranged, information indicating the type of said object, and information concerning the location of said object.

7. The interface preparation system according to claim 5, wherein said object is displayed for each page in said object window, and wherein said event processor performs a page switching process for deleting a page displayed in said object window and displaying the next page.

8. The interface preparation system according to claim 7, further comprising:
a browser for displaying a predetermined image on said display device; and
overall control means for permitting the page switching process performed by said event processor to interact with the switching of a page displayed by said browser.

9. A data processing system for accepting, as an entry, the manipulation by a user to an input screen on a display device and for performing a corresponding process, comprising the steps of:
using a browser to display an image on said display device, and to form an input screen by combining said image and an object used for input that is controlled by a process separate from said browser;
detecting an event that has occurred as a result of the manipulation of said object by said user; and
performing a predetermined process in accordance with said detected event, and permitting said predetermined process to interact with said browser.

10. A storage medium which stores a program, which can be read by an input means of a computer and instruct said computer to perform:
a process for reading a definition for an object, given on a desired page extracted from an object definition file, which defines a function of said object, and a display form for said object on said display device for each page that is set up in accordance with specific input;
a process for displaying said object on said display device in accordance with said definition that is read;
a process for detecting an event that has occurred as a result of the manipulation of said object by said user; and
a process that is performed in accordance with said event.

11. The storage medium according to claim 10, wherein said process for displaying said object includes a program for permitting a browser, mounted in said computer, to display a predetermined image, and for preparing said input screen by combining said object with said predetermined image.

12. A program transmission apparatus comprising:
storage means for storing a program that permits a computer to perform
a process for reading a definition for an object of a desired page from an object definition file that defines a function of said object and a form of said object displayed on said display device for each page that is set up in accordance with specific input,
a process for displaying said object on said display device in accordance with said definition that is read,
a process for detecting an event that has occurred as a result of the manipulation of said object by a user, and
a process that is being performed in accordance with said event; and
transmission means for reading said program in said storage means and for transmitting said program.

13. The program transmission apparatus according to claim 12, wherein said process for displaying said object includes a program for permitting a browser mounted in said computer to display a predetermined image, and for preparing said input screen by combining said object with said predetermined image.
